(19) United States
(12) Patent Application Publication
(10) Pub. No.: US 2004/0171363 A1
(43) Pub. Date: Sep. 2, 2004

(54) Graphics selecting method, graphics selecting device, graphic selecting program, graphic ediding method, graphic ediding device, graphic ediding program, and recording medium where the programs are recorded

(76) Inventor: Mitsuru Minakuchi, Soraku-gun (JP)

Correspondence Address: BIRCH STEWART KOLASCH & BIRCH, PO BOX 747, FALLS CHURCH, VA, 22040-0747, US

(21) Appl. No.: 10/482,481

(22) PCT Filed: Jun. 20, 2002
(86) PCT No.: PCT/JP02/06187

(30) Foreign Application Priority Data
Jul. 2, 2001 (JP) 2001-200254

(51) Int. Cl. H04B 1/18

(52) U.S. Cl. 455/170.1; 455/186.2

(57) ABSTRACT

A graphics selecting device for selecting a graphic on a display screen by button operation is arranged so as to include button associating means (103) for associating a plurality of buttons (102) with a plurality of graphic elements to be selected, such as apexes, edges, and planes; button operation sensing means (105) for sensing an operation on the plurality of buttons (102); and graphic element selecting means (106) for selecting one of the graphic elements that is associated by the button associating means (103) with one or more of the buttons whose operation is sensed by the button operation sensing means (105).

### TECHNICAL FIELD

The present invention relates to a graphics selecting method, graphics selecting device, and graphics selecting program for selecting by button operation on a cellular phone unit, for example, a graphic displayed on a screen; a graphics editing method, graphics editing device, and graphics editing program for editing the selected graphic by button operation; and a recording medium recording the graphics selecting program or the graphics editing program.

### BACKGROUND ART

In these years, graphic input and editing using a personal computer, etc. has been put into practical use.

The personal computer allows an input through an input unit such as a mouse, keyboard, joystick, pen tablet, and touch panel.

These input units are used to input and edit graphics generally in a method as described below. A pointing device such as a mouse, tablet, and touch panel, which is capable of directly indicating a certain position on a display screen, can allow graphic input by moving the device as if drawing a curve, for example. Alternatively, the pointing device can allow graphic editing by indicating and selecting a target graphic on screen, and performing the operation of movement such as parallel movement and rotation movement and the operation of transformation of the shape. These operations are generally called direct operation.

Further, an input unit such as a keyboard and joystick can allow a cursor indicating a certain position on the display screen to move so as to perform graphic input and editing in a manner similar to the pointing device. As for the keyboard, a key such as a cursor key, which corresponds to a direction of moving the cursor, may be held down or repeatedly pressed so as to move the cursor in the direction corresponding to the key. Further, the joystick can allow the cursor to move in a direction of pulling down the stick.

Further, Japanese Unexamined Patent Publication 312233/1998 (Tokukaihei 10-312233; published on Nov. 24, 1998) describes a method for designating a target point. This method has the steps of dividing a display screen into many areas respectively corresponding to key positions of a numerical keypad, selecting an area including a target point among these divided areas, and repeating the area selection until the target point coincides with an index point that is displayed on the display screen by the area division of key operation.

A small device such as a cellular phone unit has become capable of sufficiently inputting and editing a graphic, as throughput of the small devices has been improving.

However, most small devices have restriction on their input units. For example, as the input unit, an existing cellular phone unit generally has only buttons such as dial buttons.

Further, some types of the small devices include a touch panel, but a tool such as a pen is required to indicate a certain position on the small display screen. This degrades portability because of the need to carry the tool such as a pen, and degrades operability because the operation requires both hands. Further, this requires extra cost for providing the touch panel.

It is possible to move the cursor on the display screen using dial buttons in the same manner as the operation on the keyboard as described above. With this, however, operational efficiency is not good because moving the cursor to a certain position by the button operation is difficult and time-consuming.

The method described in Tokukaihei 10-312233 has an objective to improve efficiency in the button operation of designating a target point. With this, however, the button operation needs to be repeated to indicate a desired position. For example, it is assumed that nine keys are used to designate a position with a precision of one dot on a display screen which is a 200×200 dot bit map display, in accordance with the method described in Tokukaihei 10-312233. Here, when the number of repeating the operation required in this case is n, n has a value of 5, which is the minimum natural number that causes the nth power of 3 to be larger than 200.

### DISCLOSURE OF INVENTION

An object of the present invention is to provide a graphics selecting method, graphics selecting device, and graphics selecting program capable of improving the operability in selecting a graphic by button operation; a graphics editing method, graphics editing device, and graphics editing program capable of improving operability in editing a graphic by button operation; and a recording medium recording the graphics selecting program or the graphics editing program.

In order to attain the foregoing object, a graphics selecting method of the present invention for selecting a graphic using a plurality of buttons is arranged to have the steps of (A) associating the plurality of buttons with a plurality of graphic elements to be selected; (B) sensing an operation on the plurality of buttons; and (C) selecting one of the graphic elements that is associated in the step (A) with one or more of the buttons whose operation is sensed in the step (B).

Here, the graphic elements are constituents of graphics, for example, including points such as apexes; lines such as edges and sides; and planes such as polygons and circles. Further, the graphic elements may be control points for characterizing a curve, or virtual graphic elements such as a mask area for setting a display effect on a certain area.

Further, the step (A) may be carried out when the graphic elements to be selected are newly created or when the processing of selecting one of the graphic elements is selected. With the former, the user can operate the buttons efficiently after memorizing the associated buttons once, because the graphic elements are always associated with the same buttons in inputting and editing a graphic. On the other hand, with the latter, intuitive button operation can be realized by employing a button layout similar to a graphic element layout on the display screen, such that an upper left graphic element on the display screen is associated with an upper left button.

With this method, in the step (A), the buttons are associated with the graphic elements to be selected. In the step (B), an operation on the buttons is sensed, and in the step (C), one of the graphic elements associated with one or more of the buttons whose operation is sensed is selected.

When selecting a graphic, the user mostly selects a graphic element, such as a point, line, and plane, which constitutes a plotted graphic. In order to select such a graphic element, it is not necessary to indicate a certain position on the display screen. By allowing the user to simply select a graphic element, it is possible to improve the efficiency in the graphics editing operation.

With this method, only by operating one of the buttons once, the user can select one of the graphic elements associated with the operated button, thereby improving the operability.

In order to solve the problem, a graphics selecting device of the present invention for selecting a graphic using a plurality of buttons is arranged so as to include the plurality of buttons; button associating means for associating the plurality of buttons with a plurality of graphic elements to be selected, such as apexes, edges, and planes; button operation sensing means for sensing an operation on the plurality of buttons; and graphic element selecting means for selecting one of the graphic elements that is associated by the button associating means with one or more of the buttons whose operation is sensed by the button operation sensing means.

With this arrangement, the button associating means associates the buttons with the graphic elements to be selected. The button operation sensing means senses an operation on the buttons, and the graphic element selecting means selects one of the graphic elements associated with one or more of the buttons whose operation is sensed. Therefore, only by operating one of the buttons once, the user can select one of the graphic elements associated with the operated button, thereby improving the operability.

In order to solve the foregoing problem, a graphics selecting program of the present invention causes a computer to implement the graphics selecting method as described above.

With this, electronic devices such as a typical computer and a cellular phone unit having a function of a computer can implement the graphics selecting method as described above.

In order to solve the foregoing problem, a graphics editing method of the present invention for editing a selected graphic using a plurality of buttons is arranged to have the steps of (A) associating the plurality of buttons with a plurality of editing operations performable on a selected graphic element; (B) sensing an operation on the plurality of buttons; and (C) performing on the selected graphic element one of the editing operations that is associated in the step (A) with one or more of the buttons whose operation is sensed in the step (B).

Here, the editing is an operation of changing the position of a graphic element by moving the graphic element vertically, horizontally, or rotationally, etc.; changing the shape, display color, and line type of a graphic element; deleting and duplicating a graphic element; dividing and adding an edge; cornering; curving; moving, adding, and deleting an apex; and other processing.

With this method, in the step (A), the buttons are associated with editing operations performable on a selected graphic element. In the step (B), an operation on the buttons are sensed, and in the step (C), one of the editing operations that is associated with one or more of the buttons is performed. Therefore, the user can perform one of the editing operations on the selected graphic element in a manner similar to the operation of selecting one of the graphic elements, thereby improving the operability.

In order to solve the problem, a graphics editing device of the present invention for editing a selected graphic using a plurality of buttons is arranged so as to include the plurality of buttons; button associating means for associating the plurality of buttons with a plurality of editing operations performable on a selected graphic element; button operation sensing means for sensing an operation on the plurality of buttons; and graphic element editing means for performing on the selected graphic element one of the editing operations that is associated by the button associating means with one or more of the buttons whose operation is sensed by the button operation sensing means.

With this arrangement, the button associating means associates the buttons with the editing operations performable on a selected graphic element. The button operation sensing means senses an operation on the buttons, and the graphic element editing means performs one of the editing operations that is associated by the button associating means with one or more of the buttons whose operation is sensed. Therefore, the user can perform one of the editing operations on the selected graphic element in a manner similar to the operation of selecting one of the graphic elements, thereby improving the operability.

In order to solve the foregoing problem, a graphics editing program of the present invention causes a computer to implement the graphics editing method as described above.

With this, electronic devices such as a typical computer and a cellular phone unit having a function of a computer can implement the graphics editing method as described above.

Note that, by employing a computer-readable recording medium containing the graphics selecting program or graphics editing program, any computer can execute the program.

For a fuller understanding of the nature and advantages of the invention, reference should be made to the ensuing detailed description taken in conjunction with the accompanying drawings.

### BRIEF DESCRIPTION OF DRAWINGS

FIG. 1 is a block diagram used for explaining an arrangement of a graphics selecting device of the present invention.

FIG. 2 is a flow chart used for explaining a flow of processing of selecting a graphic element.

FIG. 3 is an overview of a cellular phone unit capable of implementing a graphic selecting method and graphic editing method of the present invention.

FIGS. 4(a) through 4(c) are display examples of a display screen in a case where a graphic is selected.

FIGS. 5(a) through 5(c) are display examples of a display screen in a case where an edge contained in a graphic is selected.

FIG. 6 is a display example of a display screen where a menu is called.

FIGS. 7(a) through 7(c) are display examples of a display screen in a case where an apex contained in a graphic is selected.

FIG. 8 is an example of a display screen on which apexes are displayed together with symbols representing associated dial keys.

FIG. 9 is a diagram used for explaining another example where button associating means associates dial keys with apexes constituting a circle.

### BEST MODE FOR CARRYING OUT THE INVENTION

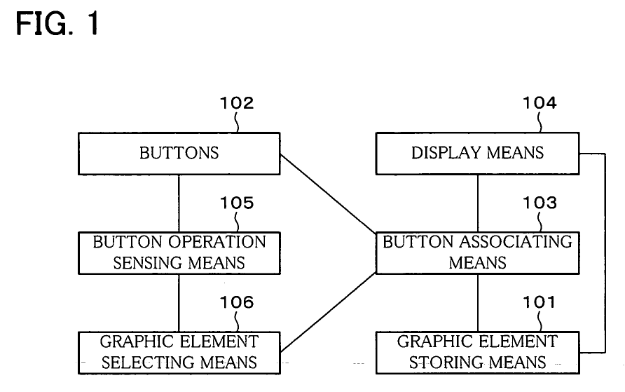

The following will explain an embodiment of the present invention with reference to FIGS. 1 through 9.

FIG. 1 is a block diagram used for explaining an arrangement of a graphics selecting device of the present invention. This arrangement can implement a graphics selecting method relating to the present invention.

FIG. 1 shows graphic element storing means 101 which stores graphic elements; a plurality of buttons 102; button associating means 103 which associates the buttons 102 with graphic elements which are to be selected among the graphic elements stored in the graphic element storing means 101, display means 104 which displays the graphic elements stored in the graphic element storing means 101, symbols representing the buttons 102 that are associated by the button associating means 103, and the like; button operation sensing means 105 which senses an operation on the buttons 102 such as the pressing of one of the buttons 102; and graphic element selecting means 106 for selecting the graphic element associated by the button associating means 103 with the button whose operation is sensed by the button operation sensing means 105.

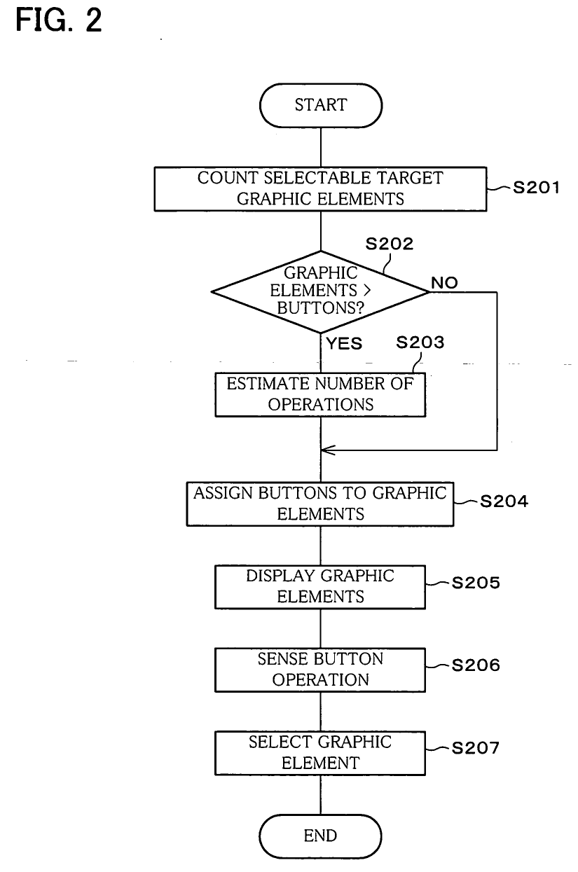

FIG. 2 is a flow chart used for explaining a flow of processing in which the graphics selecting device as arranged in FIG. 1 selects a graphic element.

First, the button associating means 103 counts the selectable target graphic elements among the graphic elements stored in the graphic element storing means 101 (step 201; hereinafter referred to as S201).

Here, the selectable target graphic elements are graphic elements which can be selected (which are worth selecting) during graphic editing. For example, graphic editing of moving an apex constituting a plane has the steps of, first, selecting a plane to be edited, and then selecting the apex to be moved among apexes constituting the selected plane. In this procedure of graphic editing, first, the planes are the selection targets, and after a certain plane is selected, apexes constituting the plane are the selection targets.

Next, the button associating means 103 judges whether the graphic element count in S201 is larger than the number of the buttons 102 (S202). If the graphic elements count in S201 is larger than the number of the buttons 102, the processing proceeds to S203. If the graphic element count in S201 is not larger than the number of the buttons 102, the processing proceeds to S204.

If the button associating means 103 judges in S202 that the graphic element count in S201 is larger than the number of the buttons 102, the graphic element count in S201 need to be associated with a combination of two or more button operations. Here, the combination of two or more button operations may be sequential operations in which a first button is pressed and released, and then a second button is pressed and released, or a simultaneous operation in which a second button is pressed and released with a first button being held down, for example. Further, the first button and the second button may be the same in the former, sequential operations.

Then, the button associating means 103 estimates the number of button operations that need to be combined (S203). For example, in the operation method of sequentially pressing and releasing the button, the graphic elements can be selected in the number of nth power of the number of the buttons 102, where the number of operations in a combination is n.

If the button associating means 103 judges after S203 or in S202 that the graphic element count in S201 is not larger than the number of the buttons 102, the button associating means 103 assigns button operations to the selectable target graphic elements counted in S201 (S204). If the number of button operations to be assigned has been estimated in S203, the estimated number of combinations of the operations are assigned. A concrete example will be described later.

In S204, the graphic elements may be respectively assigned to the buttons in any manner, but intuitive button operation may be realized by employing a button layout similar to the graphic element layout on the display screen. A concrete example will be described later.

Next, the display means 104 displays the graphic elements stored in the graphic element storing means 101 (S205). Here, the graphic element assigned to the button operation in S203 may be displayed with a symbol representing the associated button, or with a display attribute pre-assigned to the associated button.

Here, the symbol representing the button is numbers 1 through 9 and special characters such as # and * in a case of a cellular phone unit, for example. The symbols may also be characters assigned to keys on a typical keyboard, or symbols such as a circle and triangle which do not appear on the buttons. Further, the display attribute is display color, line type, painting pattern, and the like.

Next, the button operation sensing means 105 senses a user's operation on the buttons 102 (such as the pressing of a button) (S206). S206 is repeated until the button operation sensing means 105 senses an operation on the buttons 102. Alternatively, if the graphic element is assigned to a combination of two or more button operations in S204, the button operation sensing means 105 repeats sensing an operation on the buttons 102 until the number of sensing operations equals the number of operations estimated in S203.

Next, the graphic element selecting means 106 selects the graphic element that has been assigned in S204 with respect to the button 102 sensed in S206 (S207). Then, the graphics selecting device terminates the processing of selecting the graphic elements.

The following will explain a concrete example of the graphics selecting method and graphics editing method of the present invention.

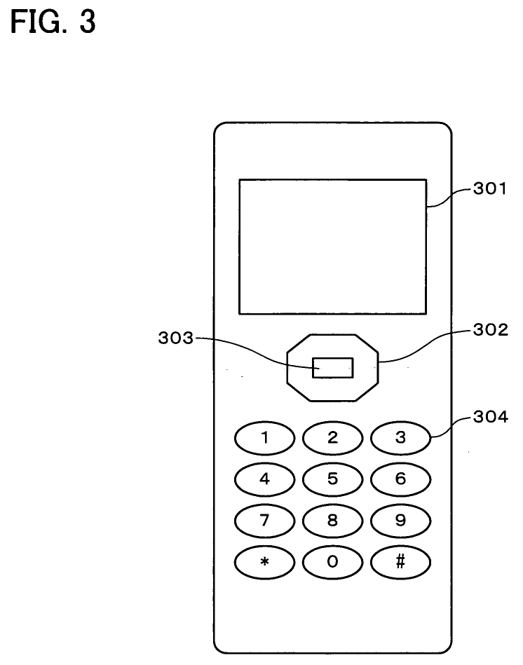

FIG. 3 is an overview of a cellular phone unit capable of implementing the graphics selecting method and graphics editing method of the present invention. FIG. 3 shows a display screen 301, a direction key 302, a menu key 303, and dial keys 304. Hereinafter, the button associating means 103 is assumed to associate graphic elements with numeric keys corresponding to numbers 0 through 9 among the dial keys 304.

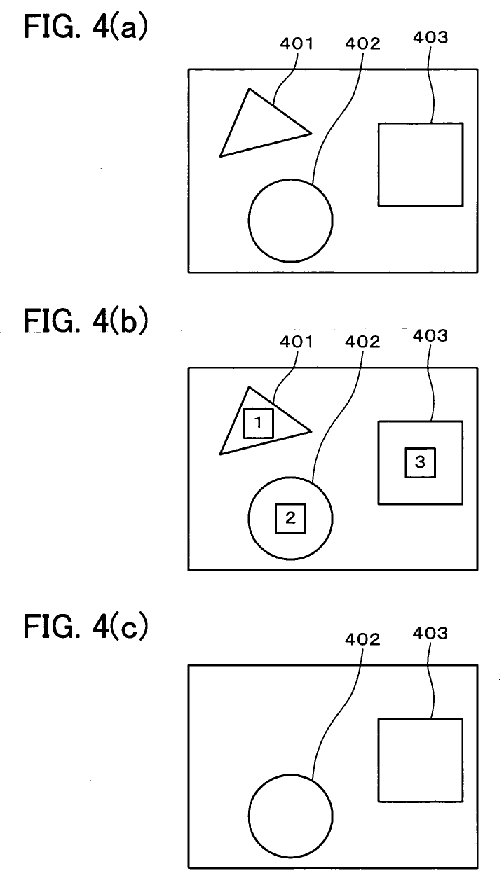

FIG. 4 is a display example of the display screen 301 in a case where graphics are edited on the cellular phone unit as shown in FIG. 3. FIG. 4(a) is the screen including a plurality of graphics (polygons, circles, etc.). In FIG. 4(a), the screen for editing shows a triangle 401, a circle 402, and a square 403. Here, it is assumed that processing of deleting a graphic is selected, for example. The operation for selecting the processing includes the steps of pressing the menu key 303 to cause the display screen 301 to display an operation menu, operating the menu key 303 to indicate a menu corresponding to the graphics deleting processing among displayed menu items, and then pressing the menu key 303 again to select the menu, for example.

In the graphics deleting processing, the graphics are respective selection targets. Thus, the button associating means 103 regards the graphics as editing targets among the graphic elements stored in the graphic element storing means 101, and associates the graphics with the dial keys 304 (buttons 102).

In accordance with the above-described processing of S201 through S204, the processing of associating the graphic elements with the dial keys 304 is as follows. Namely, the button associating means 103 counts the graphics among the graphic elements stored in the graphic element storing means 101 (S201), and obtains the number of 3. Since the dial keys 304 have ten numeric keys, the number of the graphics is smaller than the number of the numeric keys (S202). Thus, the button associating means 103 assigns the dial keys 304 respectively to the graphics (S204).

FIG. 4(b) is an example of the display screen 301 on which the display means 104 displays the graphics together with symbols representing the associated dial keys 304 in S205, after the processing of S201 through S204 as described above. The framed numbers at the respective centers of the graphics are the symbols representing the dial keys 304.

In FIG. 4(b), the numbers of the dial keys 304 are respectively assigned in ascending order with the graphics on the display screen 301 sequentially from left to right. This can be realized in the processing of S204 in such a manner that the button associating means 103 associates the dial keys 304 in ascending order with the graphics in ascending order of the lateral coordinate of the centers of the graphics.

Note that, the graphics counted in S201 may not be all the graphics stored in the graphic element storing means 101, but may be only the graphics displayed on the display screen 301. This is effective in such cases where the display screen 301 displays some of all the graphic elements being edited or does not display some of the graphic elements.

It is assumed that the user wants to delete the triangle 401 from the display screen 301 of FIG. 4(b). Since the triangle 401 is assigned to a key “1” among the dial keys 304, the user can select the triangle 401 by pressing “1” of the dial keys 304. The selected triangle 401 is deleted and the resultant display screen 301 is as shown in FIG. 4(c).

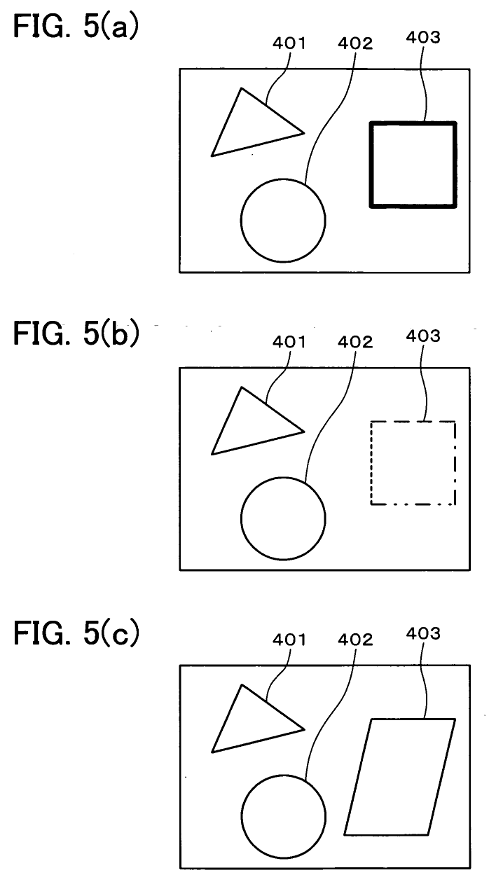

FIG. 5 is a display example of the display screen 301 as in FIG. 4. The following will explain an example where an edge in a graphic is selected. The graphics editing processing for selecting an edge may be processing of transforming a graphic by moving a selected edge, for example.

It is assumed here that the user selects processing that requires edge selection by selecting the menu in the same manner as explained referring to FIG. 4. The button associating means 103 may regard all edges as editing targets among the graphic elements stored in the graphic element storing means 101 and associate the edges with the dial keys 304 in the same manner as described above. Here, however, the selecting operation is performed in such a sequential procedure that the user first selects the graphic containing an edge to be edited, selects the menu, and selects the edge in the selected graphic.

Operation for the user to select the graphic containing the edge to be edited is similar to the operation as explained referring to FIG. 4. Here, the user is assumed to select the square 403. FIG. 5(a) shows the display screen 301 in this state. Here, edges of the square 403 are shown thicker than edges of the other graphics in order to distinguish the selected graphic, namely the square 403, from the other graphics, but how to display the selected graphic is not limited to this. The selected graphic may be displayed together with a mark such as a frame, or the display color of the selected graphic may be changed into a predetermined display color representing that the graphic is being selected.

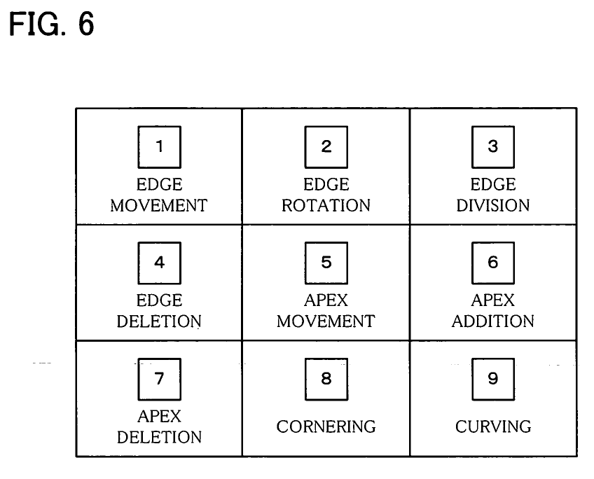

When the display screen 301 is as shown in FIG. 5(a), it is assumed that the user presses the menu key 303 to call the menu in order to select the processing of transforming a graphic by edge movement, the processing requiring edge selection. FIG. 6 shows a display example of the display screen 301 in this state.

In FIG. 6, editing operations performable when a graphic is selected are shown respectively together with symbols representing the dial keys 304. The display screen 301 displays “1” with edge movement, “2” with edge rotation, “3” with edge division, “4”, with edge deletion, “5”, with apex movement, “6” with apex addition, “7” with apex deletion, “8” with cornering, and “9” with curving among the dial keys 304. The dial keys 304 are associated with editing operations instead of graphic elements in the same manner as in the processing explained referring to FIG. 2. The user may press “1” of the dial keys 304 so as to select “edge movement” which is processing for moving an edge. The processing for this is the same as the processing explained referring to FIG. 2.

When the processing of “edge movement” is selected, the button associating means 103 regards edges constituting the square 403 as selection targets, and associates the edges with the dial keys 304 in a manner similar to the above-described processing.

The display means 104 may display the edges together with symbols representing the associated dial keys 304 in the same manner as described above. Here, as another display method, FIG. 5(b) shows an example where the edges are displayed by different line types respectively pre-assigned to the dial keys 304. In FIG. 5(b), the edges contained in the square 403 are displayed by a dotted line, a broken line, a chain line, and a chain double-dashed line. If the line types are fixedly associated with the dial keys 304, the user can refer to an instruction manual, etc. to know the dial key 304 associated with a desired edge.

Alternatively, the button associating means 103 may associate the edges constituting the square 403 with the dial keys 304 in such a manner that the layout of the dial keys 304 is similar to the positions of the selectable target graphic elements. For example, the button associating means 103 may associate the edges constituting the square 403 with the dial keys 304 as shown in FIG. 3 by associating a left edge with “4”, a right edge with “6”, an upper edge with “2”, and a lower edge with “8”, because the positions of the edges seen from the center of the square 403 are similar to the layout of those keys of the dial keys 304. In this way, the user can select a graphic element using the dial key 304 roughly corresponding to a desired direction. Further, the relationship between the dial keys 304 and the line types may be displayed on a certain position of the display screen 301.

It is assumed that the user wants to move the base of the square 403 so as to transform the square 403 on the display screen 301 of FIG. 5(b). If “8” is the dial key 304 corresponding to a chain double-dashed line, which is the line type by which the base of the square 403 is displayed, the user may press “8” of the dial keys 304 to select the base of the square 403. After selecting the base, the user may operate the direction key 302 to move the base to a desired position, and press a key for terminating the movement (menu key 303, for example) to terminate the processing of transforming a graphic by edge movement. FIG. 5(c) shows an example after the transformation.

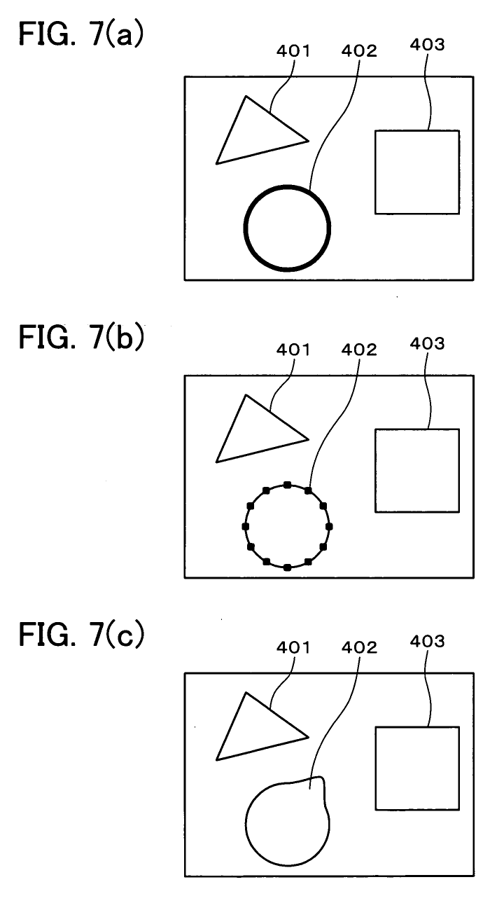

FIG. 7 is a display example of the display screen 301 as in FIG. 4. The following will explain an example where an apex contained in a graphic is selected. The graphics editing processing for selecting the apex may be processing of transforming a graphic by moving a selected apex, for example.

It is assumed that the processing requiring apex selecting is selected by selecting the menu in the same manner as explained referring to FIG. 4. Here, in a similar manner as described above, the user performs selecting operation by selecting a graphic containing an apex to be edited, selecting the menu, and then selecting the apex contained in the selected graphic. FIG. 7(a) is the display screen 301 when the user has selected the circle 402 in the same manner as explained referring to FIG. 5.

In this state of the display screen 301 shown in FIG. 7(a), it is assumed that the user presses the menu key 303 to call the menu in FIG. 6, and presses “5” of the dial keys 304 to select from the menu “apex movement” which is processing for transforming a graphic by apex movement. The button associating means 103 regards the apexes constituting the circle 402 as editing targets and associates the apexes with the dial keys 304 in the same manner as the above-described processing. FIG. 7(b) shows as an example the selectable target apexes on the display screen 301. Here, it is assumed that the circle 402 is composed of twelve apexes, and expressed as a curve passing through the apexes. Thus, the circle can be transformed into a closed curve by moving some of the apexes.

Here, the dial key 304 has ten numeric keys, which are more than the apexes constituting the circle 402. Accordingly, the button associating means 103 associates the apexes with the dial keys 304 in the following manner. Namely, the button associating means 103 counts the apexes constituting the circle 402 among the graphic elements stored in the graphic element storing means 101, and obtains the number, 12 (S201). Since the dial keys 304 have ten numeric keys, the number of the apexes is larger than the number of the numeric keys (S202). If each of the apexes is assigned to an method of sequentially carrying out an operation such that the dial key 304 is pressed and released (S203), the button associating means 103 estimates that one hundred graphic elements at most can be assigned to the dial keys 304 by combining two operations on the dial keys 304. Thus, the button associating means 103 associates each of the apexes with a combination of operations in which two numeric keys such as “0” and “1”, “0” and “2”, . . . “1 and 2” are pressed (S204).

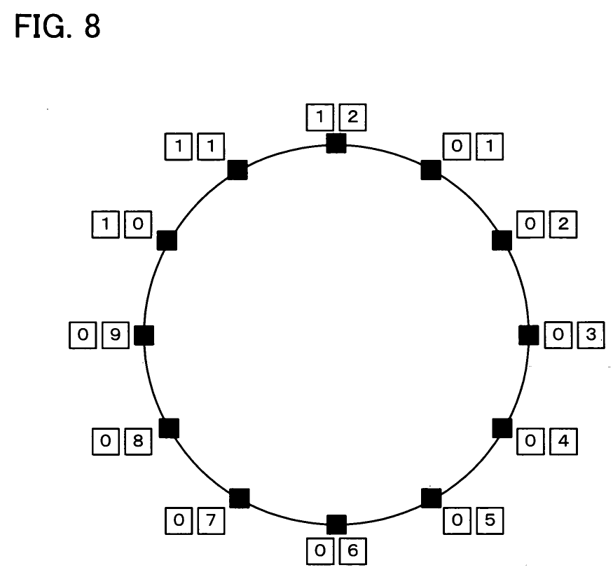

FIG. 8 shows an example of the display screen 301 on which the apexes are displayed together with symbols representing the associated dial keys 304.

With the display screen 301 as shown in FIG. 8, the user presses and releases “0” of the dial keys 304, and then presses and releases “1”, in order to select an apex to be moved. With these sequential operations, an upper right (one o'clock) apex of the circle 402 is selected in the processing of S207. After selecting the apex, the user may operate the direction key 302 to move the apex to a desired position and complete the movement, thereby completing the processing of transforming a graphic by apex movement. FIG. 7(c) shows an example after the transformation.

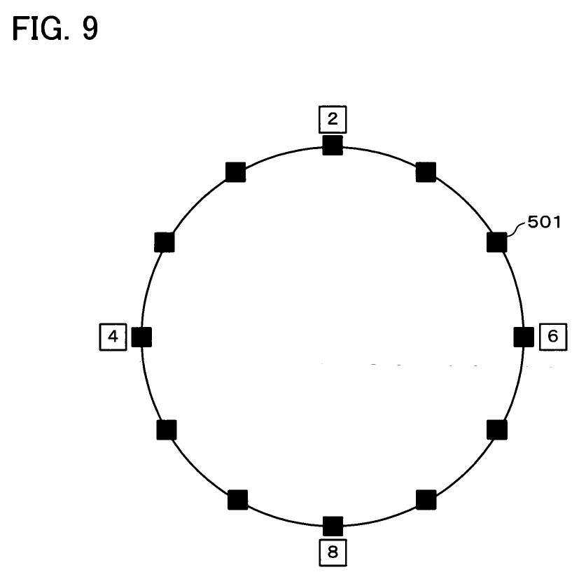

FIG. 9 is a diagram used for explaining another example in which the button associating means 103 associates the dial keys 304 with the apexes constituting the circle 402. In this example, the dial keys 304 are not associated with all the apexes, but with only apexes whose positions have similarity with the layout of the dial keys 304. Namely, the top, right, bottom, and left apexes of the circle 402 are respectively associated with “2”, “6”, “8”, and “4” which are symbols of the dial keys 304. An apex that is not associated with the dial key 304 may be selected by selecting an apex near a desired apex using the dial keys 304, and then pressing an “*” or “#” key, as a key for selecting an adjacent apex, to change the selected apex, for example.

The processing of changing the selected apex is performed in the manner as described below, for example. Namely, when the “*” or “#” key is pressed, the graphic element selecting means 106 searches for a graphic containing the currently selected apex from the graphics stored in the graphic element storing means 101. Further, the graphic element selecting means 106 searches for the apexes constituting the graphic. Then, the graphic element selecting means 106 newly selects an apex adjacent. clockwise to the selected apex when “*” is pressed, and an apex adjacent counterclockwise to the selected apex when “#” is pressed; and deselects the previously selected apex. In order to store apexes constituting a graphic, a data structure such as a list structure which stores the apexes together with the storage locations of information regarding the adjacent apexes may be used to easily obtain an adjacent apex. However, other data structures may also be used to obtain an adjacent apex by comparing coordinate values of the apexes.

In this manner, the user can select the apex 501 by pressing “6” of the dial keys 304 to select the apex corresponding to “6”, and then pressing “#” once which is a key for selecting the apex adjacent counterclockwise to the currently selected apex, for example. Alternatively, the same result may be achieved by pressing “2” of the dial keys 304 to select the apex corresponding to “2”, and then pressing “*” twice which is a key for selecting the apex adjacent clockwise to the currently selected apex.

The graphics selecting method and graphics editing method as explained above are realized by a program for executing processing of the graphics selecting method and graphics editing method. This program is stored in a computer-readable recording medium. As the recording medium, the present invention may use a program medium including a memory such as ROM (Read Only Memory) integrated in or connected with a typical computer, or a recording medium readable by being inserted into a program reading device provided as an external storing device, because the processing is performed by a typical computer.

In either case, the stored program may be executed by access of a microprocessor. Alternatively, in either case, the program may be executed after being read out and then downloaded on a program storage area such as RAM (Random Access Memory) which is configured in a typical computer. The program for downloading is prestored in the main unit.

Here, the program medium may be a recording medium arranged to be detachable from the main unit. The recording medium may be a medium fixedly carrying a program, including a tape type such as a magnetic tape and a cassette tape; a disk type including a magnetic disk such as a floppy (registered trademark) disk and a hard disk, and an optical disk such as CD-ROM, MO, MD, and DVD; a card type such as an IC card (including a memory card) and an optical card; a semiconductor memory such as mask ROM, EPROM, EEPROM, and flash ROM.

Further, the present invention has a system configuration connectable with a communication network including the Internet. Thus, the recording medium may be a medium fluidly carrying a program so as to download the program from a communication network, for example. Note that, if the program is downloaded from a communication network as described above, a program for downloading may be either prestored in the main unit or installed from another recording medium.

Note that, the contents stored in the recording medium are not limited to a program but may be data.

As described above, a graphics selecting method of the present invention for selecting a graphic using a plurality of buttons is arranged to have the steps of: (A) associating the plurality of buttons with a plurality of graphic elements to be selected; (B) sensing an operation on the plurality of buttons; and (C) selecting one of the graphic elements that is associated in the step (A) with one or more of the buttons whose operation is sensed in the step (B).

With this method, only by operating one of the buttons once, the user can select one of the graphic elements associated with the operated button, thereby improving the operability.

Alternatively, the graphics selecting method of the present invention is arranged so that in the step (A), each of the graphic elements to be selected is associated with a combination of two or more button operations if the graphic elements are more than the buttons.

With this method, it is possible to select one of the graphic elements by a few button operations even if the graphic elements to be selected are more than the buttons.

Alternatively, the graphics selecting method of the present invention is so arranged that the step (A) includes the substep of displaying the graphic elements to be selected, either together with symbols representing the buttons associated with the graphic elements or with display attributes pre-assigned to the buttons associated with the graphic elements.

With this method, in the case where the graphic elements are displayed with the symbols, the user can operate one of the buttons corresponding to a desired one of the graphic elements by referring to the symbols representing the buttons. This allows the user to easily select the one of the buttons to be operated.

Further, in the case where the graphic elements are displayed with the display attributes, the user can operate one of the buttons corresponding to a desired one of the graphic elements by referring to the display attributes of the graphic elements, even if the symbols, etc., cannot be displayed with the graphic elements due to reasons such that the display screen is too small.

As described above, a graphics selecting device of the present invention for selecting a graphic using a plurality of buttons is arranged so as to include the plurality of buttons; button associating means for associating the plurality of buttons with a plurality of graphic elements to be selected, such as apexes, edges, and planes; button operation sensing means for sensing an operation on the plurality of buttons; and graphic element selecting means for selecting one of the graphic elements that is associated by the button associating means with one or more of the buttons whose operation is sensed by the button operation sensing means.

With this method, only by operating one of the buttons once, the user can select one of the graphic elements associated with the operated button, thereby improving the operability.

As described above, a graphics selecting program of the present invention causes a computer to implement the graphics selecting method as described above.

With this, electronic devices such as a typical computer and a cellular phone unit having a function of a computer can implement the graphics selecting method as described above.

As described above, a graphics editing method of the present invention is arranged so as to include the steps of (A) associating the plurality of buttons with a plurality of editing operations performable on a selected graphic element; (B) sensing an operation on the plurality of buttons; and (C) performing on the selected graphic element one of the editing operations that is associated in the step (A) with one or more of the buttons whose operation is sensed in the step (B).

With this method, the user can perform one of the editing operations on the selected graphic element in a manner similar to the operation of selecting one of the graphic elements, thereby improving the operability.

As described above, the graphics editing method of the present invention is arranged so that in the step (A), each of the editing operations is associated with a combination of two or more button operations if the editing operations are more than the buttons.

With this method, it is possible to perform one of the editing operations by a few button operations even if the editing operations are more than the button. Alternatively, the graphics selecting method of the present invention is so arranged that the step (A) includes the substep of displaying the editing operations, either together with symbols representing the buttons associated with the editing operations or with display attributes pre-assigned to the buttons associated with the editing operations.

With this method, the display screen displays the editing operations associated with the buttons in the substep of displaying the editing operations, so that the user can easily select a desired one of the editing operations.

Further, in the case where the editing operations are displayed with the symbols, the user can operate one of the buttons corresponding to a desired one of the editing operations by referring to the symbols representing the buttons. This allows the user to easily select the one of the buttons to be operated.

Further, in the case where the editing operations are displayed with the display attributes, the user can operate one of the buttons corresponding to a desired one of the editing operations by referring to the display attributes, even if the symbols, etc., cannot be displayed with the graphic elements due to reasons such that the display screen is too small.

As described above, a graphics editing device of the present invention is arranged so as to include the plurality of buttons; button associating means for associating the plurality of buttons with a plurality of editing operations performable on a selected graphic element; button operation sensing means for sensing an operation on the plurality of buttons; and graphic element editing means for performing on the selected graphic element one of the editing operations that is associated by the button associating means with one or more of the buttons whose operation is sensed by the button operation sensing means.

With this arrangement, the user can perform one of the editing operations on the selected graphic element in a manner similar to the operation of selecting one of the graphic elements, thereby improving the operability.

As described above, a graphics editing program of the present invention causes a computer to implement the graphics editing method as described above.

With this, electronic devices such as a typical computer and a cellular phone unit having a function of a computer can implement the graphics editing method as described above.

Note that, by employing a computer-readable recording medium containing the graphics selecting program or graphics editing program, any computer can execute the program.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### Industrial Applicability

With the present invention, it is possible to provide a graphics selecting method for selecting a graphic on small devices such as a cellular phone unit using a plurality of buttons, the graphics selecting method including the steps of (A) associating the plurality of buttons with a plurality of graphic elements to be selected, (B) sensing an operation on the plurality of buttons, and (C) selecting one of the graphic elements that is associated with one or more of the buttons whose operation is sensed; a graphics selecting device; a graphics selecting program; and a recording medium recording the graphics selecting program.

With the present invention, it is possible to provide a graphics editing method for editing a selected graphic using a plurality of buttons, the graphics editing method including the steps of (A) associating the plurality of buttons with a plurality of editing operations performable on a selected graphic element, (B) sensing an operation on the plurality of buttons, and (C) performing on the selected graphic element one of the editing operations that is associated with one or more of the buttons whose operation is sensed; a graphics editing device; a graphics editing program; and a recording medium recording the graphics editing program.

This can improve operability in selecting and editing a graphic by button operation.

1. A graphics selecting method for selecting a graphic on a display screen using a plurality of buttons, comprising the steps of:
(A) assigning the plurality of buttons to a plurality of graphic elements to be selected, based on a layout of the graphic elements on the display screen, when selecting one of the graphic elements;
(B) sensing an operation on the plurality of buttons; and
(C) selecting one of the graphic elements that is assigned in the step (A) to one or more of the buttons whose operation is sensed in the step (B).

2. The graphics selecting method as set forth in claim 1, wherein:
in the step (A), each of the graphic elements to be selected is assigned to a combination of two or more button operations if the graphic elements are more than the buttons.

3. The graphics selecting method as set forth in claim 1 or 2, wherein:
the step (A) includes the substep of displaying the graphic elements to be selected, either together with symbols representing the buttons assigned to the graphic elements or with display attributes pre-assigned to the buttons assigned to the graphic elements.

4. A graphics selecting device for selecting a graphic on a display screen using a plurality of buttons, comprising:
the plurality of buttons;
button associating means for assigning the plurality of buttons to a plurality of graphic elements to be selected, based on a layout of the graphic elements on the display screen, when selecting one of the graphic elements;
button operation sensing means for sensing an operation on the plurality of buttons; and
graphic element selecting means for selecting one of the graphic elements that is assigned by the button associating means to one or more of the buttons whose operation is sensed by the button operation sensing means.

5. (Canceled)

6. A graphics editing method for editing a selected graphic on a display screen using a plurality of buttons, comprising the steps of:
(A) in response to selection of one of editing operations performable on selected graphic elements, assigning the plurality of buttons to the plurality of graphic elements to be subjected to the selected one of the editing operations, based on a layout of the graphic elements on the display screen;
(B) sensing an operation on the plurality of buttons; and
(C) performing the selected one of the editing operations on one of the graphic elements that is assigned in the step (A) to one or more of the buttons whose operation is sensed in the step (B).

7. The graphics editing method as set forth in claim 6, wherein:
in the step (A), each of the graphic elements to be subjected to the selected one of the editing operations is assigned to a combination of two or more button operations if the graphic elements are more than the buttons.

8. The graphics editing method as set forth in claim 6 or 7, wherein:
the step (A) includes the substep of displaying the graphic elements to be subjected to the selected one of the editing operations, either together with symbols representing the buttons assigned to the graphic elements or with display attributes pre-assigned to the buttons assigned to the graphic elements.

9. A graphics editing device for editing a selected graphic on a display screen using a plurality of buttons, comprising:
the plurality of buttons;
button associating means for, in response to selection of an editing operation performable on selected graphic elements, assigning the plurality of buttons to the plurality of graphic elements to be subjected to the selected editing operation, based on a layout of the graphic elements on the display screen;
button operation sensing means for sensing an operation on the plurality of buttons; and
graphic element editing means for selecting one of the graphic elements that is assigned by the button associating means to one or more of the buttons whose operation is sensed by the button operation sensing means.

10. (Canceled)

11. (Canceled)

12. The graphics selecting method as set forth in claim 1, wherein:
in the step (A), the plurality of buttons are assigned to the plurality of graphic elements to be selected in such a manner that a layout of the buttons is similar to a layout of the graphic elements on the display screen.

13. The graphics selecting method as set forth in claim 1, wherein:
in the step (A), the plurality of buttons are sequentially assigned to the plurality of graphic elements to be selected, starting from one of the graphic elements on a predetermined position on the display screen.

14. The graphics selecting method as set forth in claim 1, wherein:
the step (B) includes the substep of switching the selection of the graphic elements from the selected one to an adjacent one on the display screen by sensing an operation on a predetermined one of the buttons.

15. A graphics selecting program for causing a computer to implement the graphics selecting method as set forth in claims 1 through 3 and 12 through 14.

16. The graphics editing method as set forth in claim 6, wherein:
in the step (A), the plurality of buttons are assigned to the plurality of graphic elements to be subjected to the selected one of the editing operations in such a manner that a layout of the buttons is similar to a layout of the graphic elements on the display screen.

17. The graphics editing method as set forth in claim 6, wherein:
in the step (A), the plurality of buttons are sequentially assigned to the plurality of graphic elements to be subjected to the selected one of the editing operations, starting from one of the graphic elements on a predetermined position on the display screen.

18. The graphics editing method as set forth in claim 6, wherein:
the step (B) includes the substep of switching the selection of the graphic elements from the selected one to an adjacent one on the display screen by sensing an operation on a predetermined one of the buttons.

19. The graphics editing method as set forth in claim 6, wherein:
when one of the editing operations is to be selected, the plurality of editing operations are assigned to the plurality of buttons, and the plurality of editing operations are displayed together with respective symbols representing the assigned buttons.

20. A graphics editing program for causing a computer to implement the graphics editing method as set forth in claims 6 through 8 and 16 through 19.

21. A computer-readable recording medium containing the graphics selecting program as set forth in claim 15 or the graphics editing program as set forth in claim 20.
